(19) United States
(12) Patent Application Publication
(10) Pub. No.: US 2015/0354240 A1
(43) Pub. Date: Dec. 10, 2015

(54) SPORTS STADIUM HAVING REMOVABLE FIELD

(71) Applicant: Nutcracker Solutions AS, Jar (NO)

(72) Inventors: Yngve SALTVEIT, Sandvika (NO); Claus JOHANNSEN, Jar (NO)

(73) Assignee: Nutcracker Solutions AS, Jar (NO)

(21) Appl. No.: 14/758,468

(22) PCT Filed: Dec. 27, 2013
(86) PCT No.: PCT/EP2013/078048

§ 371 Date: Jun. 29, 2015

(30) Foreign Application Priority Data
Dec. 30, 2012 (NO) 20121565

(51) Int. Cl. E04H 3/14; E04B 1/343; E04H 6/12; B66B 9/00; E04F 11/00; E04H 3/12; E04B 5/43

(52) U.S. Cl. CPC E04H 3/14; E04H 3/12; E04B 1/343; E04B 5/43; B66B 9/00; E04F 11/002; E04H 6/12; E04F 2011/007

(57) ABSTRACT

Sports stadium with a fixed support base (5) surrounded by a spectators stand (13). A field cover (2) is arranged on the fixed support base (5) and comprises a plurality of field modules (1). The field modules (1) are movable on the fixed support base (5). An aperture (14) constitutes access to a storage room (50) at a level below the fixed support base (5). A lift arrangement (60) is arranged in association with the aperture (14) and adapted for lowering and raising field modules (1) between a level (3, 4) of the storage room (50) and the level of the fixed support base (5). The storage room (50) is provided with a vehicle access port (11) on a lateral side of the storage room (50).

The present invention relates to sport stadiums having a removable field, such as a removable turf field of artificial grass or natural grass. In particular, the stadium according to the invention has a field at least partially surrounded by spectators stands and exhibits a storage room for the removable field at a level below a fixed support base.

### BACKGROUND

Modern sports stadiums are costly to build and maintain. Hence it is in the owner's interest to use it as much as possible in order to meet the costs. For instance, the home ground of a football team is used for sports typically once every second week during the season, and even less outside the season. In addition there will typically be some other matches such as cup matches. As a result, the stadium will be left unused in most of its time. In the last decades, one has started to use such stadiums also for cultural events such as large concerts. Such events constitute an important income for the stadium owners.

However, a large concert held on a natural turf field will or may destroy the grass. Means of protecting the turf are often used, but are not always sufficient. Moreover, such protecting means takes time to install and remove. As a result, the stadium owner cannot quickly change the modus of the stadium between a sports event and a cultural event. He is bound by his obligation to provide a quality turf for the sports event, making it difficult to provide possible dates for other cultural events.

This problem has existed for decades and several known solutions have been suggested to overcome it. Some solutions regard protecting or covering the field, while others involve removing the field instead of protecting it in situ.

International patent application publication WO2013002649, published 3 Jan. 2013, describes a solution where a field cover is made up of removable field modules. When in use, the field modules are supported on a fixed support base and arranged together to form a uniform surface, e.g. a football field. The field modules can be transported from the fixed support base, down to a storage room below the fixed support base through an aperture in the fixed support base. A lift arrangement is arranged in association with the aperture to move the field modules between the fixed support base and the storage room.

German publication DE2924904 from 1980 describes a floor consisting of floor modules which are adapted to cover an ice field. The modules are plates that are removed from the ice and stored below a ceiling. Thus the modules protect the ice when the ice field is not in use.

Another system adapted for protection of an existing field is described in European patent application publication EP1500416. It describes a sheet cover rolled onto a roller that is arranged in a trench. To protect the turf field, the cover is rolled out and laid onto the field.

Turfgrass Bulletin presents an article in its October issue of 2001 (Issue No. 214) describing a pitch made up of movable turf modules. The modules are approximately 1-2 m² each and are moved out of the stadium by an ordinary forklift. Below the turf modules there is a fixed support base, such as a concrete floor.

The solutions involving covering the field cover, such as a turf field, exhibit a problem in that the grass will deteriorate if covered for long periods. Furthermore, even if covered with plates or a sheet cover, events such as a concert, with all the associated equipment such as a stage and trucks and camera/sound gear and audience, will physically damage the turf.

The solutions involving removing the field cover exhibit a disadvantage in that removing the vast number of field modules is cumbersome and time consuming. Moreover, storage space for the field modules is needed either outside the stadium or within the stadium construction. The latter represents valuable space such as for office premises, shops, VIP-rooms, etc. Hence this is not a desired solution.

The object of the present invention is to provide a solution that remedies the disadvantages of the solutions according to the prior art. A particular object of the invention is to provide a solution that makes possible a quick removal of the turf field and also a quick re-assembly of the turf field. Yet another object is to provide a sports stadium that facilitates usage and increases revenue for the owner or operator of the stadium.

### THE INVENTION

According to a first aspect of the present invention, there is provided a sports stadium with a fixed support base which is surrounded by a spectators stand. A field cover is arranged on the fixed support base and comprises a plurality of field modules. The field modules are movable on the fixed support base. An aperture constitutes access to a storage room at a level below the fixed support base and a lift arrangement is arranged in association with the aperture. The lift arrangement is adapted lower or raise field modules between a level of the storage room and the level of the fixed support base. According to the invention, the storage room is provided with a vehicle access port on a lateral side of the storage room.

By the term “surrounded by spectators stand” is meant that at least some of the periphery of the field cover, when arranged on the fixed support base, is adjacent a spectators stand. Thus, in some embodiments the entire field cover may be surrounded by spectators stands, while other embodiments may for instance have spectators stand adjacent approximately ¾ of the perimeter of the field cover.

According to a preferred embodiment, the lift arrangement is arranged in association with a side of the storage room.

Preferably, the lift arrangement comprises a lift arrangement plate which is adapted to be fixed in the aperture in a position flush with the fixed support base. The fixation can be provided by means of locking mechanism.

In yet an embodiment, the storage room can comprise a plurality of levels and the vehicle access ports can be arranged at some of or all of such levels.

The lifting arrangement can be in form of a pivoting ramp. The pivoting ramp can exhibit a ramp plate that pivots between a lowered and raised position about a pivot axis arranged at the level of the fixed support base. I.e. the pivot axis can be arranged substantially at the level of the fixed support base. In this way, when the ramp plate is in the raised position, its upper face is flush with the fixed support base.

The upper face of the field cover, when arranged on the fixed support base, can advantageously be flush with a ground surface adjacent the fixed support base.

A field cover stored in the storage room can constitute support for parked vehicles. In this manner, one may store both vehicles and a field cover simultaneously at the same level of the storage room.

The storage room can be situated beneath the fixed support base. In another embodiment the storage room can be situated in a position exterior to the space directly below the fixed support base. Thus, the storage room can extend beyond the area of the fixed support base, on which the field cover and its field modules are arranged when in use.

In an advantageous embodiment, the fixed support base, a level of the storage room, and the lift arrangement comprises a built-in drive assembly adapted for moving field modules.

In an advantageous embodiment, the field modules may be moved across the fixed support base, lift arrangement and a level in the storage chamber, with a drive assembly in the form of a floor conveyor system. Such a drive assembly can include belts and tracks as means to move and position separate field modules. In use, the field modules, e.g. field modules having natural grass, may see uneven wear and tear. Consequently, a preferred feature is being able to move field modules between the rows of conveyors, enabling field modules with worn grass to alternate position with field modules possessing a better surface, or simply replacing them with spare field modules.

The drive assembly can be a conveyor belt system transporting rows of field modules across the fixed support base, elevator floor and levels of the storage room. Advantageously, each conveyor can cover one field module, thus allowing the module to be parked when it has reached a desired position. Additional conveyors may also be in a perpendicular position between to the main rows of conveyors, allowing alternate position of a floor module. Tracks or other guiding may be used to further ensure correct module positioning, both when in transport and when at standstill.

According to a second aspect of the present invention, there is provided a method of replacing a first field cover on a fixed support base of a sports stadium with a second field cover. The fixed support base is surrounded by spectators stands. Moreover, the first field cover and the second field cover comprise a plurality of field modules which are adapted to form a uniform surface when supported by the fixed support base. According to the second aspect of the present invention, the method comprises the following steps
a) repeatedly moving field modules of the first field cover onto a first lift arrangement and lowering the field modules down to a level of a storage room arranged at a vertical level below the level of the fixed support base, and when the first lift arrangement is at the level of the storage room, moving the field modules of the first field cover from the first lift arrangement to a storing position in the storage room;
b) repeatedly moving field modules of the second field cover, stored at a level in the storage room, onto a second lift arrangement and elevating the field modules up to the level of the fixed support base, and when the second lift arrangement is at the level of the fixed support base, moving the field modules of the second field cover onto the fixed support base and into a position to form a uniform surface with other field modules of the second field cover.

Advantageously, in an embodiment according to the second aspect of the invention, a first time period, in which step a) is performed and a second time period, in which step b) is performed, are overlapping.

The method can further comprise the following step:
c) receiving vehicles into the storage room through a vehicle access port arranged on a lateral side of the storage room.

Step c) can comprise parking said vehicles on field modules stored in the storage room.

In an embodiment of the method according to the second aspect of the invention, step a) can comprise lowering the field modules of the first field cover to a first level of the storage room, and step b) can comprise raising the field modules of the second field cover from a second level of the storage room, wherein the first level is at another vertical elevation than the second level.

### EXAMPLE OF EMBODIMENT

While various general features of the invention has been disclosed above, some non-limiting and detailed examples of various embodiments will be discussed in the following with reference to the drawings, in which

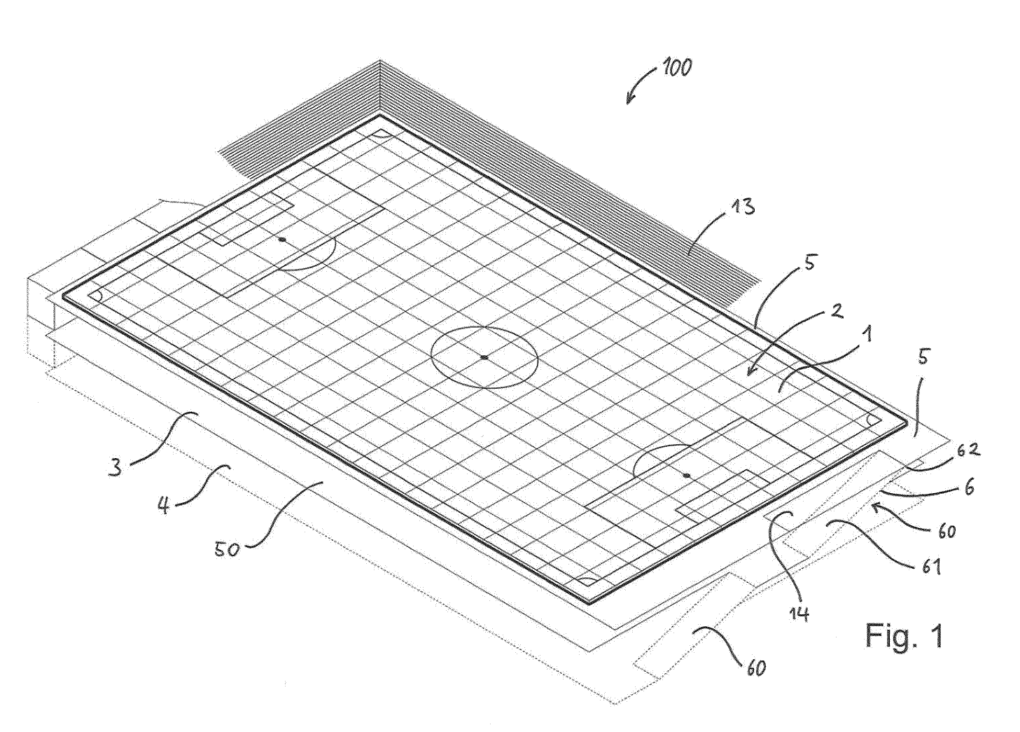

FIG. 1 is a perspective view of a sports stadium according to the invention;

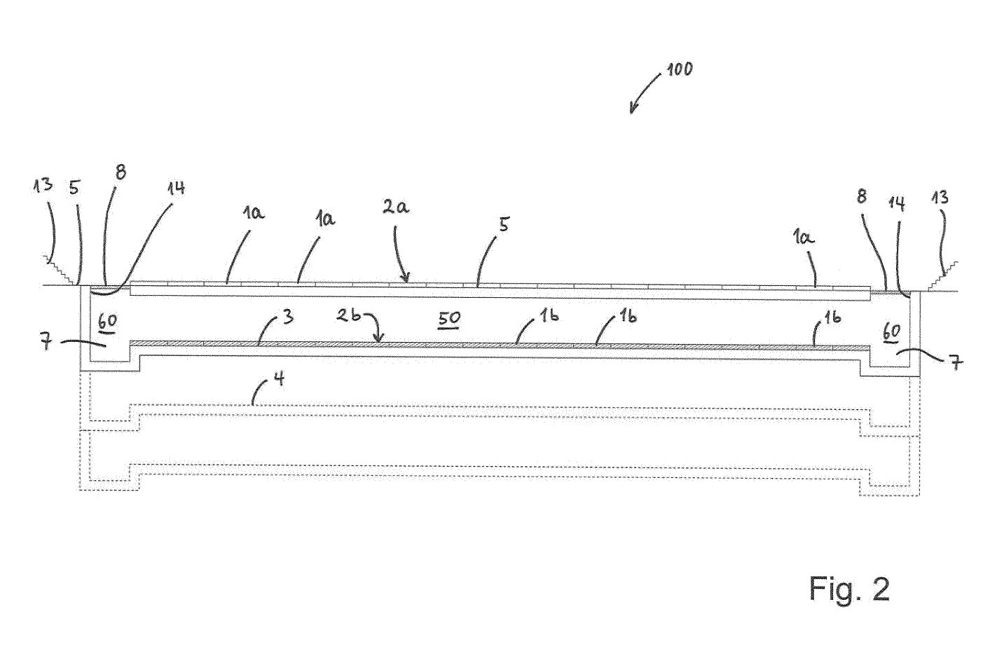

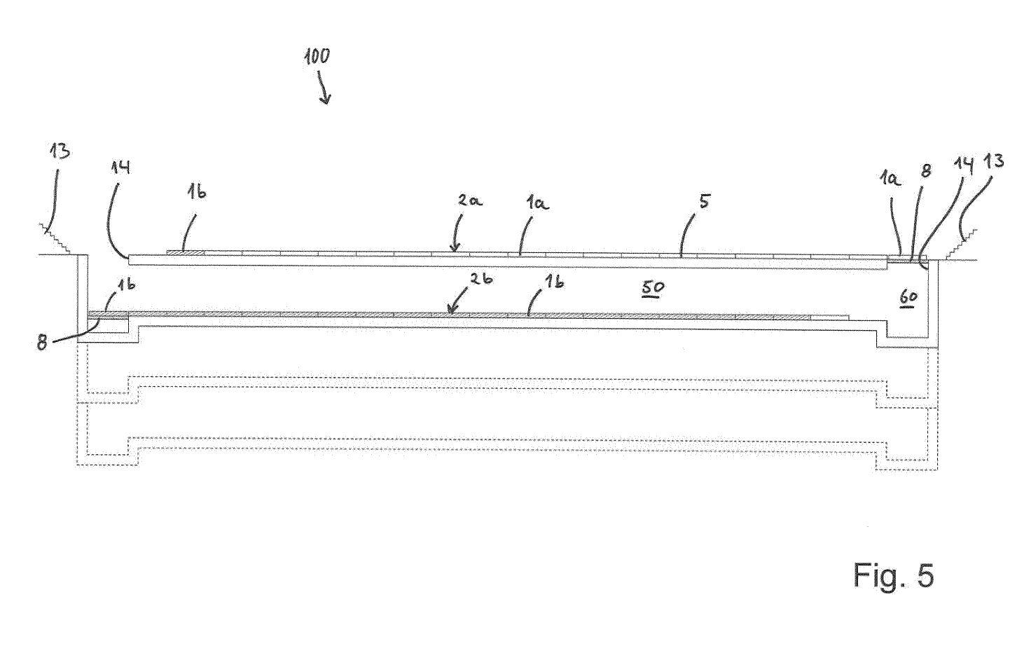

FIG. 2 to FIG. 7 are cross section views through a sports stadium according to the invention;

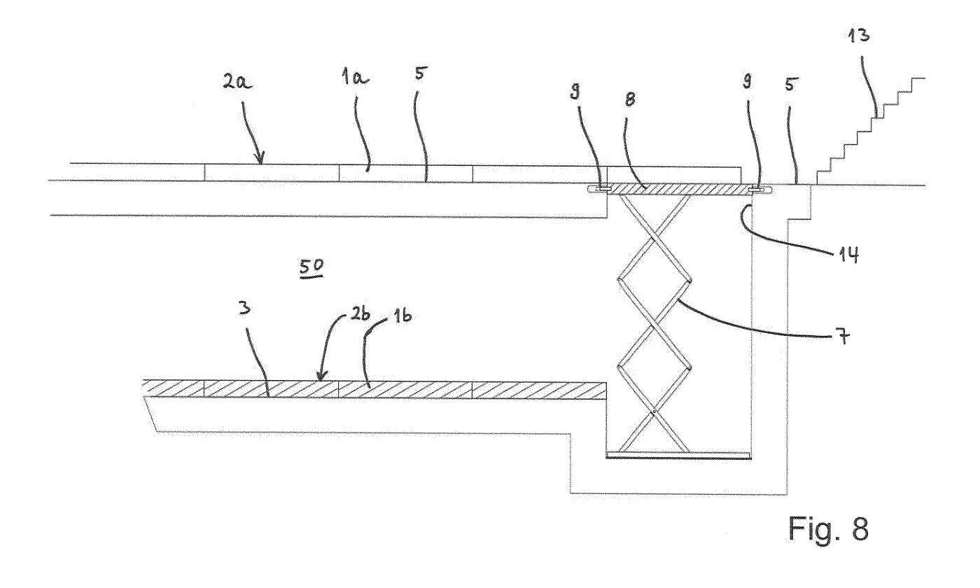

FIG. 8 is a cross section view through a section of the sports stadium according to the invention;

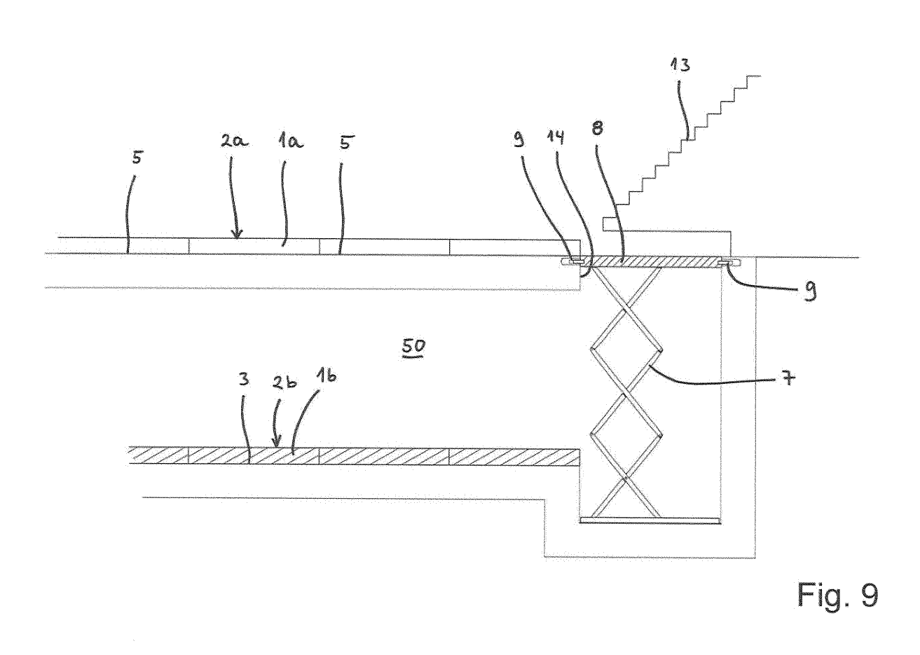

FIG. 9 is a cross section view corresponding to FIG. 8, showing a different embodiment;

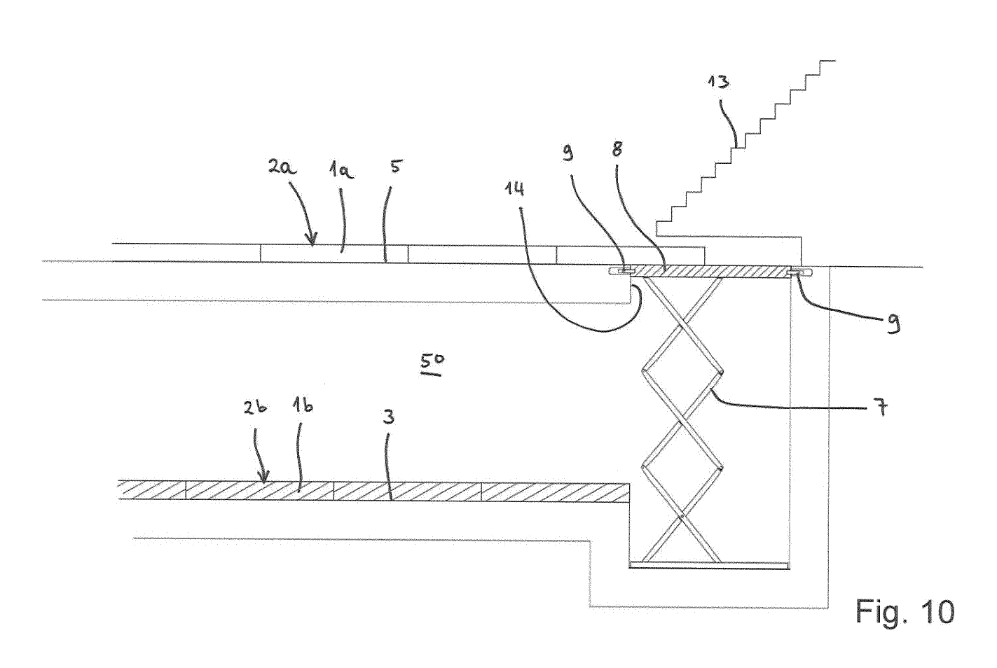

FIG. 10 is a cross section view corresponding to FIG. 9, in another operational state;

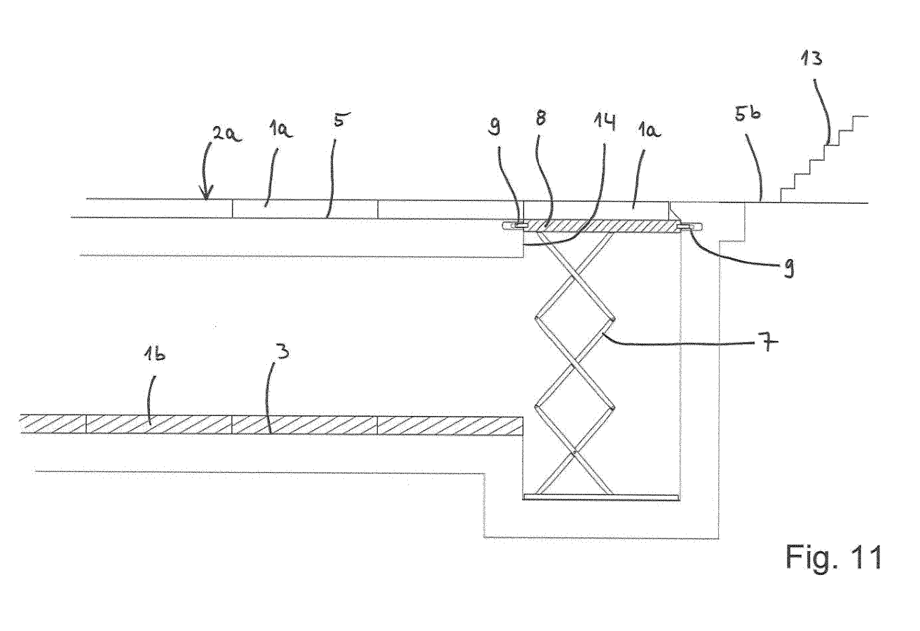

FIG. 11 is a cross section view similar to FIG. 8;

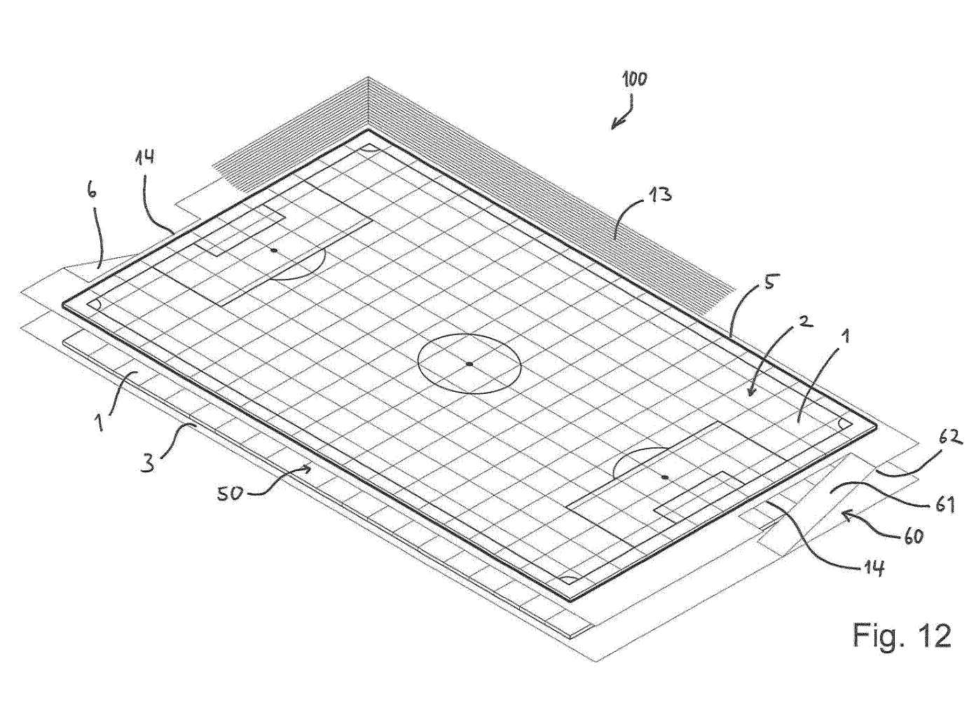

FIG. 12 is a perspective view of a sports stadium, corresponding to FIG. 1, however illustrating another embodiment;

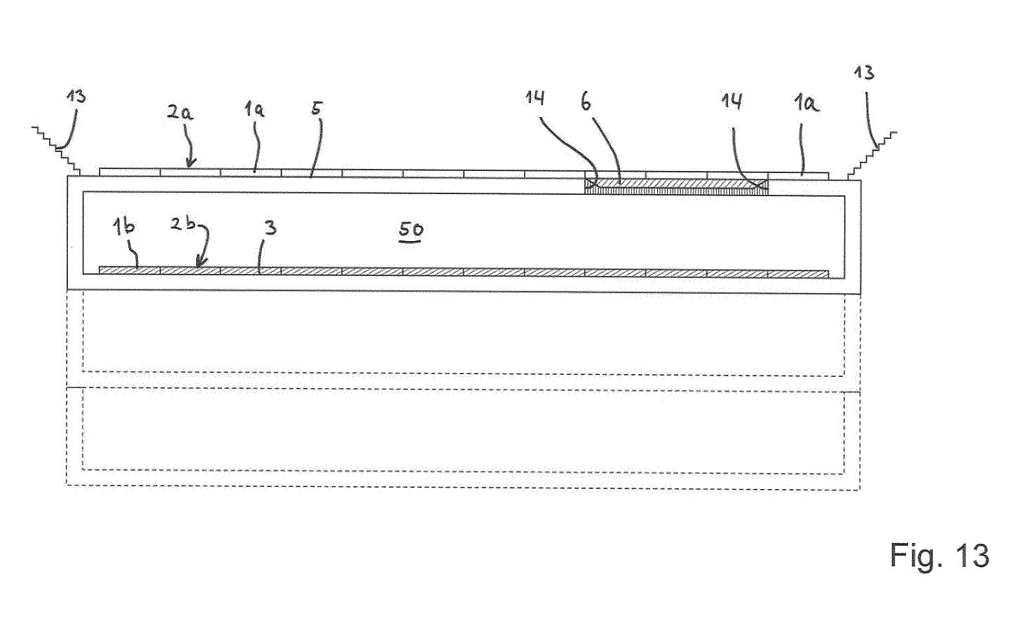

FIG. 13 is a cross section view through a sports stadium according to the embodiment shown in FIG. 12;

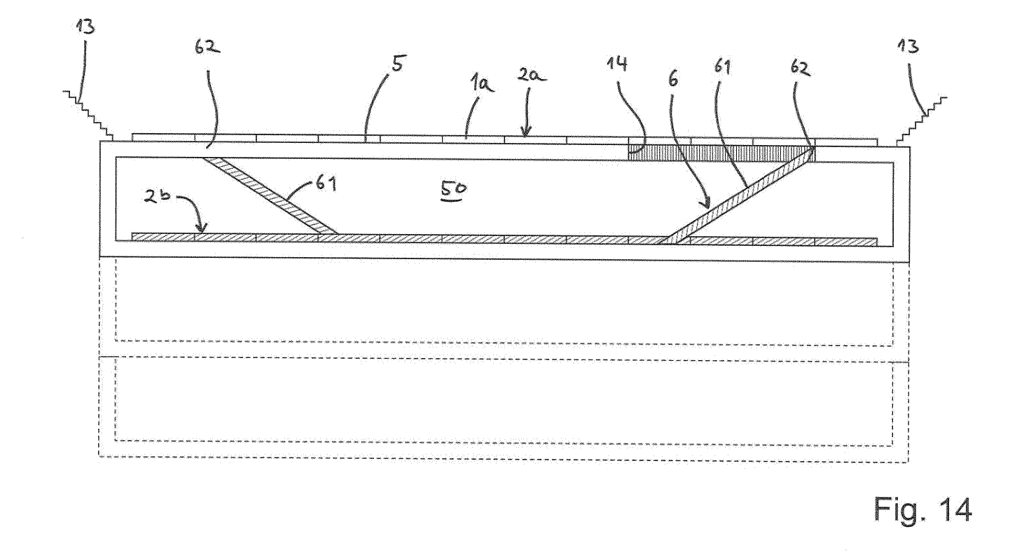

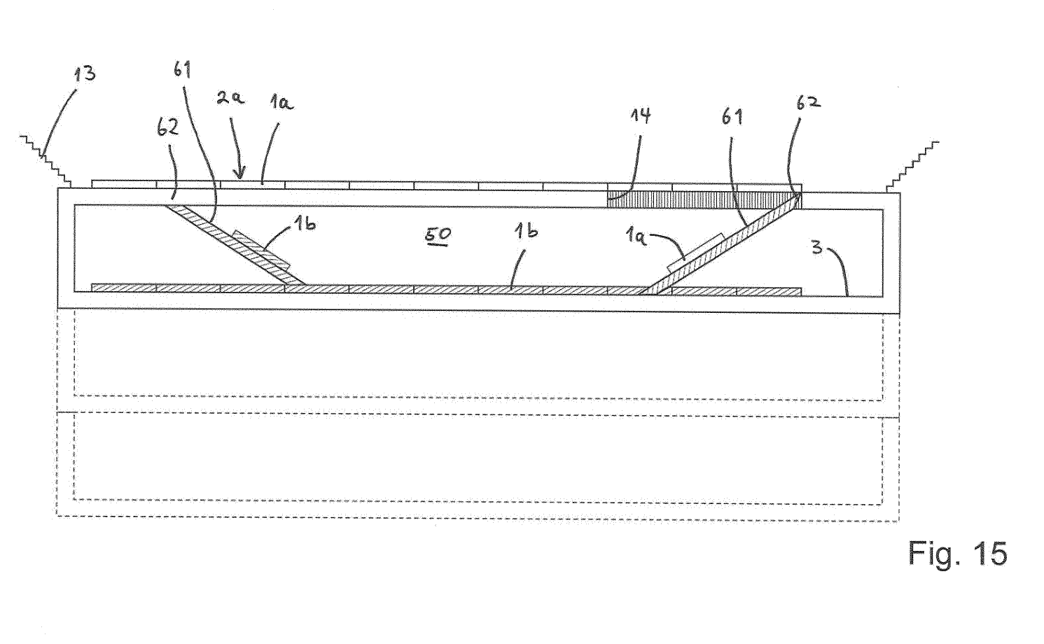

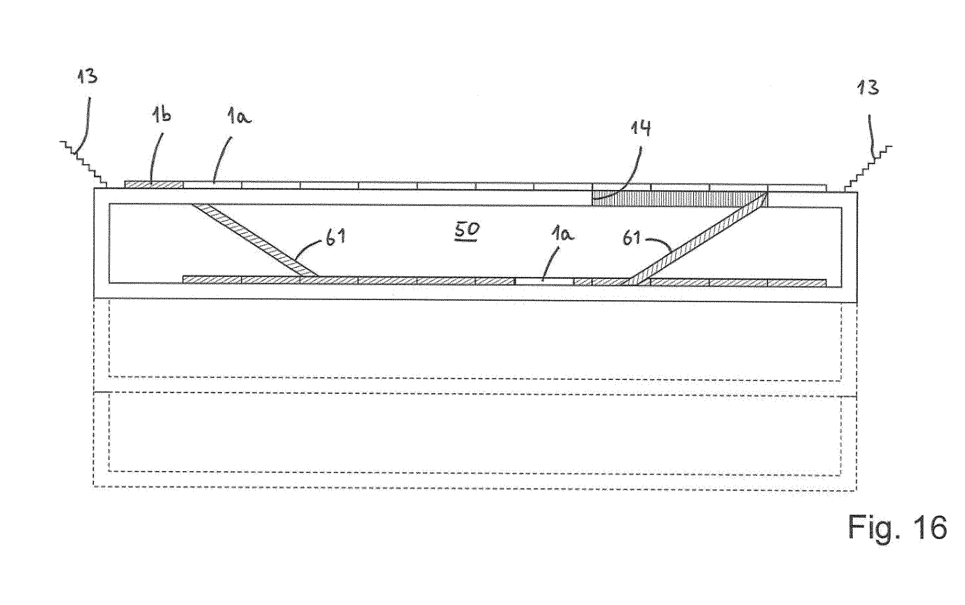

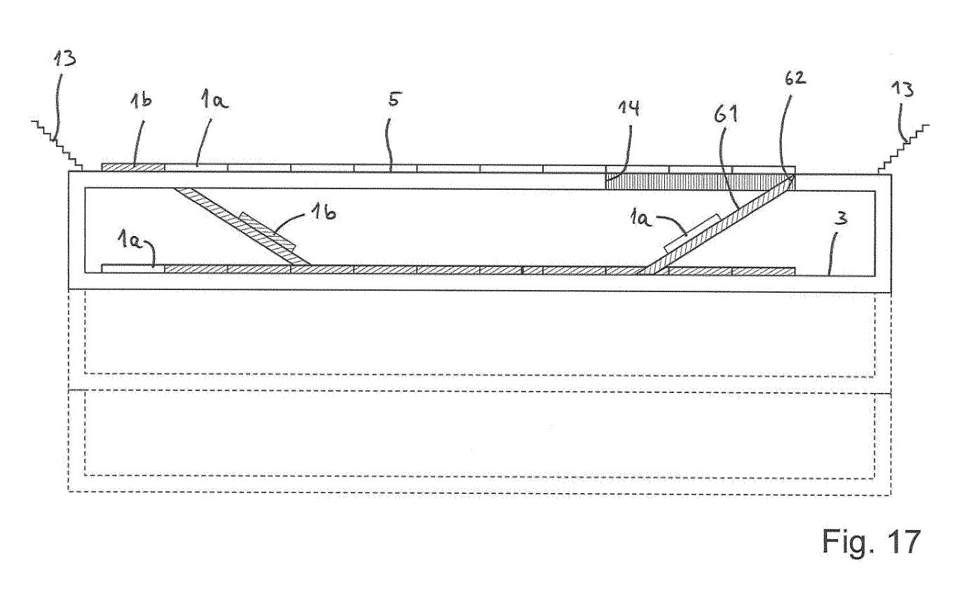

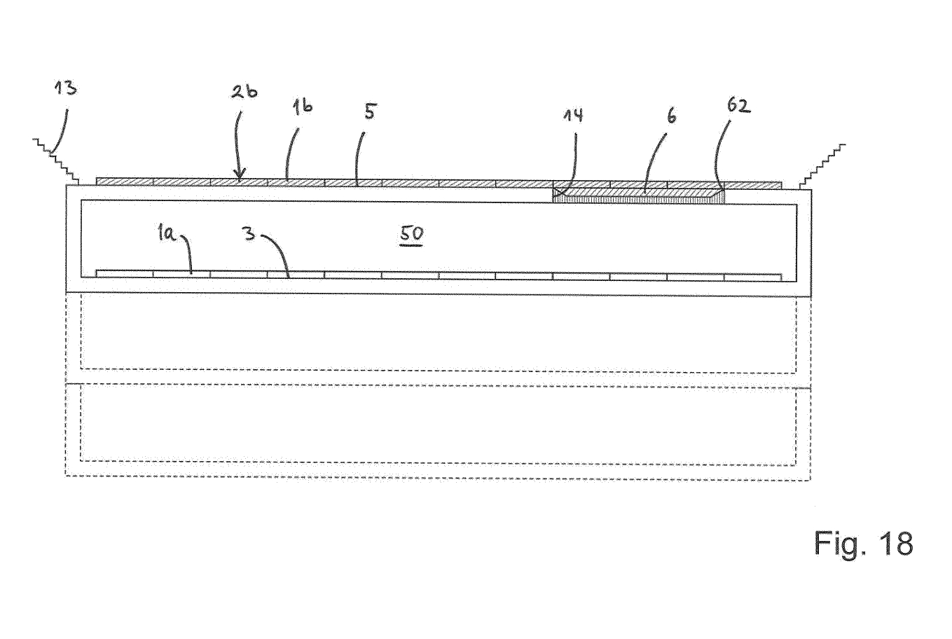

FIG. 14 to FIG. 18 are cross section views according to FIG. 13, illustrating various steps of a method according to the invention;

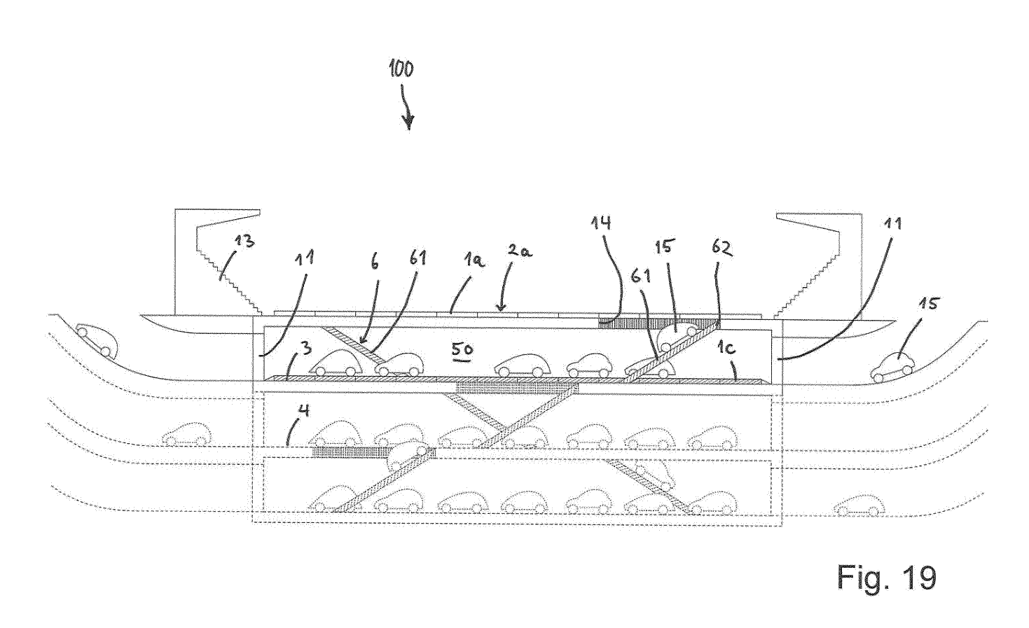

FIG. 19 is a cross section view of another embodiment of the invention; and

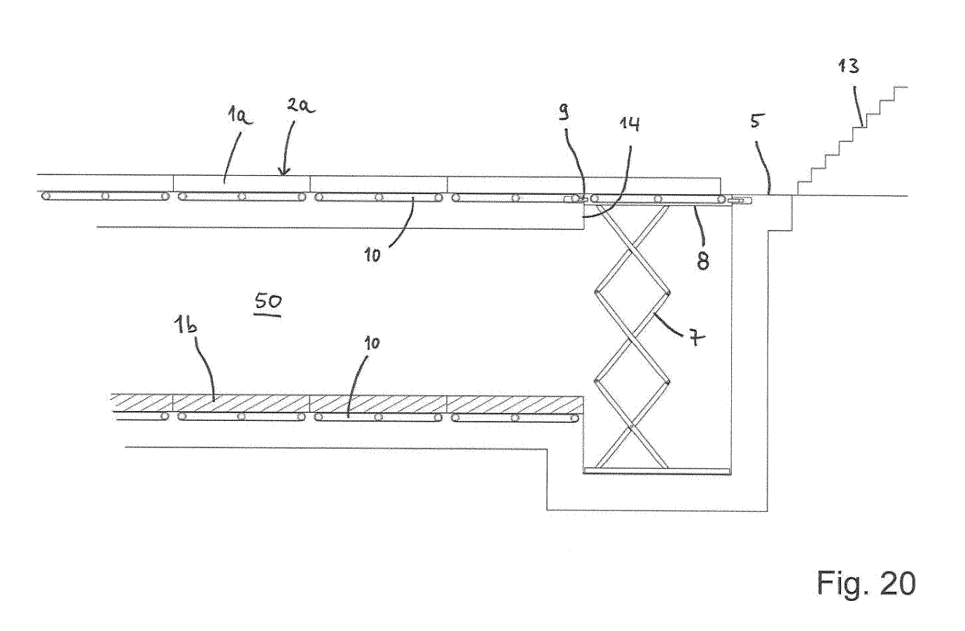

FIG. 20 is another cross section view through a portion of the sports stadium, illustrating another embodiment of the present invention.

The perspective view of FIG. 1 illustrates a sports stadium 100 according to the present invention. A portion of a spectators stand 13 that surrounds a football field is shown. The shown football field is constituted by a field cover 2 which is assembled by a plurality of field modules 1. The field modules 1 are supported on a fixed support base 5 and are movable on the fixed support base 5. Thus, the field modules 1 can be moved around on the fixed support base 5 and assembled together to constitute an entire football field or any other kind of sports field. For such sports field, natural turf or artificial grass may constitute the upper face of the field modules 1. However, for other types of events the upper face of the field modules 1 may exhibit another surface. For instance, a surface like a plain floor can be suitable if the event in question is a large concert.

In the perspective view of FIG. 1 there is shown a storage room 50 at a level below the fixed support base 5. In the shown embodiment, the storage room 50 comprises two floors or levels, namely a first level 3 and a second level 4. According to the invention, the field modules 1 can be transported between their position on the fixed support base 5 and the storage room through an aperture 14 in the fixed support base 5. In association with the aperture 14 there is arranged a lift arrangement 60. In the embodiment shown in FIG. 1, the lift arrangement 60 is in the form of a pivoting ramp 6. The pivoting ramp 6 has a ramp plate 61 that is arranged in the aperture 14 and which is adapted to pivot about a pivot axis 62 arranged substantially at the level of the fixed support base 5.

Thus, for transporting a field module 1 from the fixed support base 5 to the storage room 50, the field module 1 is moved onto the ramp plate 61 when the ramp plate is in the raised position, in which position it preferably is flush with the surface of the fixed support base 5. The ramp plate 61 is then pivoted downwards about the pivot axis 62 and the field module 1 is then moved down into the storage room 50 by moving along the inclined ramp plate 61. Once the field module 1 has left the ramp plate 61, the ramp plate 61 can be pivoted back up to the level of the fixed support base 5 to receive another field module 1 which shall be moved into to the storage room 50.

As indicated in FIG. 1, there is a pivoting ramp 6 also arranged between the first level 3 of the storage room and the second level 4 of the storage room 50.

It is now referred to the principle cross section view of FIG. 2, showing a sports stadium 100 according to the present invention. In this embodiment, a first field cover 2a is arranged on the fixed support base 5, while the field modules 1b of a second field cover 2b is arranged on the first level 3 of the storage room 50. As indicated by the dashed lines, the storage room 50 may have additional levels such as the second level 4 shown in FIG. 1 and even more levels. An increased number of levels in the storage room 50 increases the storage capabilities and hence makes it possible to store a larger number of field covers 2, typically field covers 2 of different types.

At opposite ends of the storage room 50 there is arranged a lift arrangement 60 which in this embodiment is in the form of elevators 7. The elevators 7 are not shown in FIG. 2. However, one such elevator is illustrated in the enlarged cross section view of FIG. 8. The two elevators 7 of the embodiment in FIG. 2 are arranged in association with an aperture 14 in the fixed support base 5. The elevators 7 are adapted to move an elevator plate 8 vertically up and down, between the level of the fixed support base 5 and the first level 3 of the storage room 50. Thus, by moving a first or second field module 1a, 1b onto the elevator 7, the field module can be transported between the storage room 50 and the fixed support base 50.

In the situation shown in FIG. 2, the elevator plate 8 of both elevators 7 are fixed in the respective apertures 14 at a level flush with the fixed support base 5. In this position the elevator plate 8 can be fixed so that the remains of the elevator 7 can be lowered with the elevator plate 8 remaining in the aperture 14.

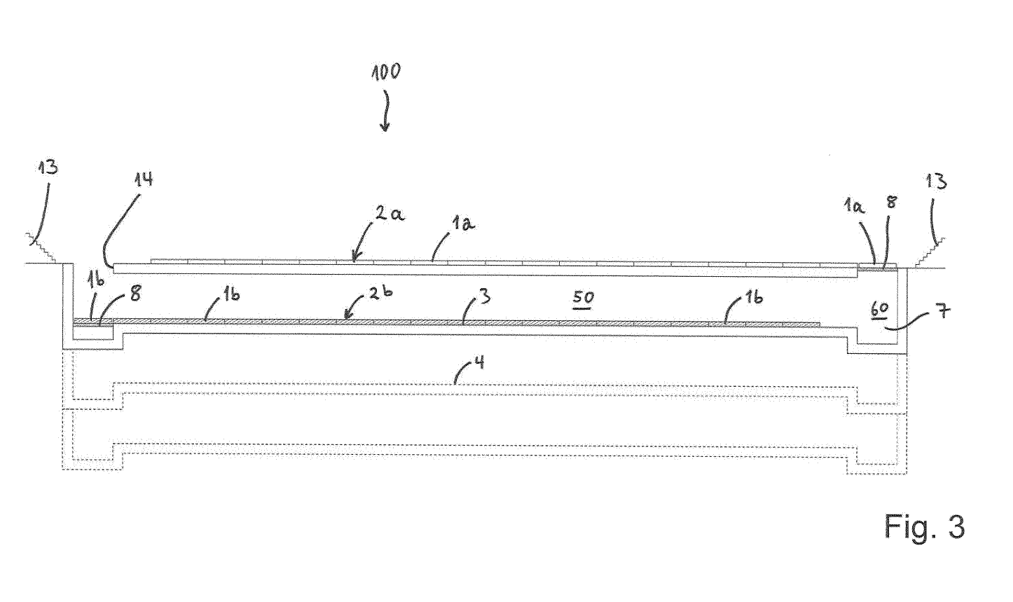

FIG. 3 shows the same cross section view as FIG. 2. In the situation shown in FIG. 3, one elevator 7 has moved the elevator plate 8 down to the first level 3 of the storage room 50. One field module 1b of the second field cover 2b has been moved onto this elevator plate 8. The other elevator plate 8, at the opposite side of the storage room 50, has received one field module 1a of the first field cover 2a.

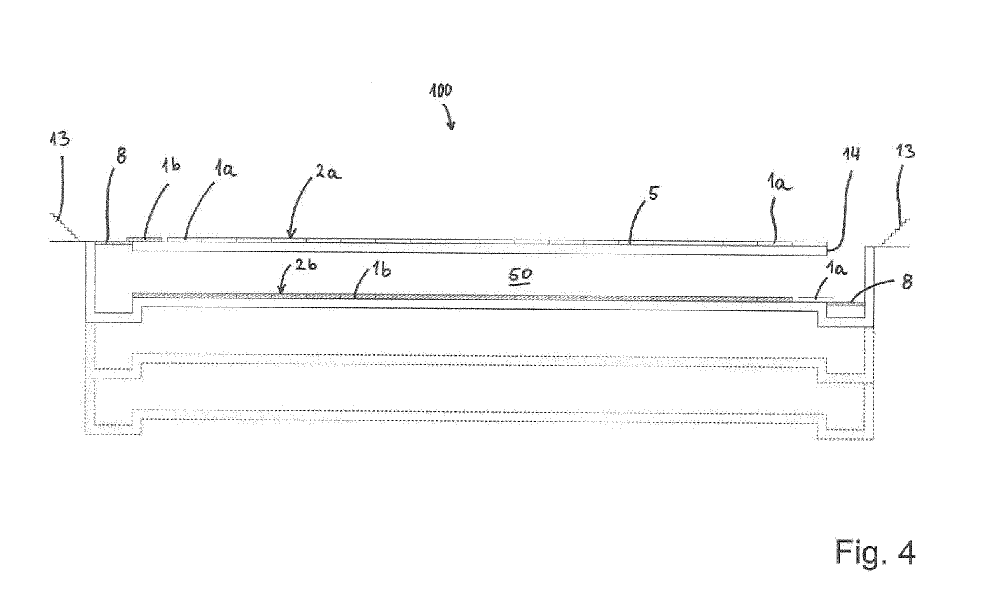

FIG. 4 shows the same cross section as FIG. 2 and FIG. 3. However, in the situation shown in FIG. 4, one elevator has moved a field module 1b of the second field cover 2b up to the level of the fixed support base 5. Moreover, this field module 1b has been moved onto the fixed support base 5. A row of, or a plurality of field modules 1a of the first field cover 2a has moved a distance towards the opposite elevator 7 and opposite aperture 14. Moreover, one field module 1a of the first field cover 2a has been moved onto the elevator plate 8 and been lowered vertically down to and moved laterally onto the first level 3 of the storage room 50. This process is repeated until the entire first field cover 2a has been replaced with the second field cover 2b which initially was stored in the storage room 50.

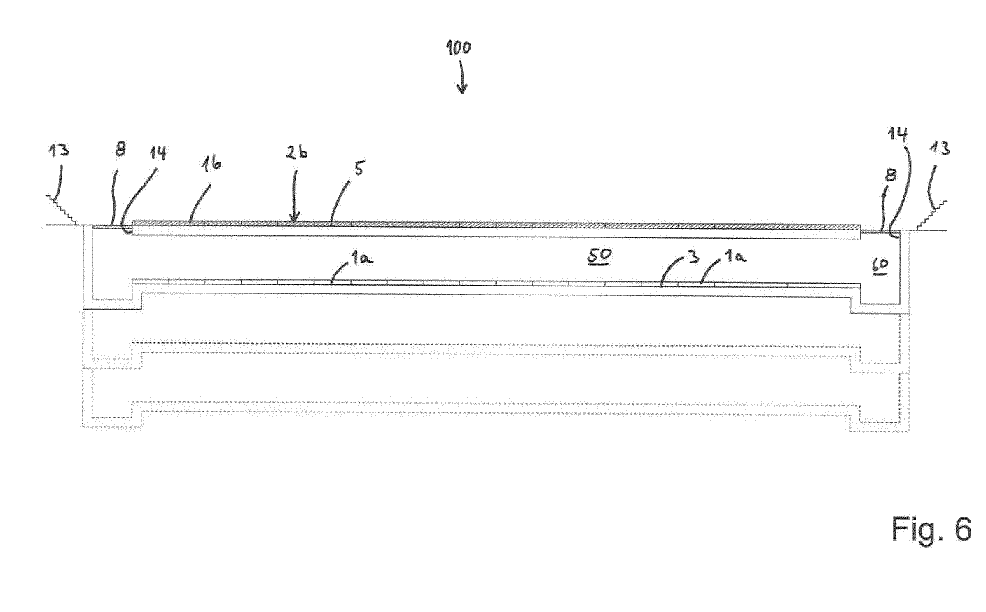

By using two oppositely arranged lift arrangements 60, which in this embodiment are in the form of elevators 7, the first field cover 2a is replaced with the second field cover 2b in a quick fashion. FIG. 6 illustrates the situation after this replacement.

It should be noted that the two apertures 14 and their associated lift arrangements 60 need not be arranged at strictly oppositely positions. However, as will be appreciated by the skilled person in the art, it is advantageous to have the apertures 14 arranged in such positions that an area on the fixed support base 5, close to one aperture, can be created when a field module 1 is moved onto the lift arrangement 60 at the other aperture 14.

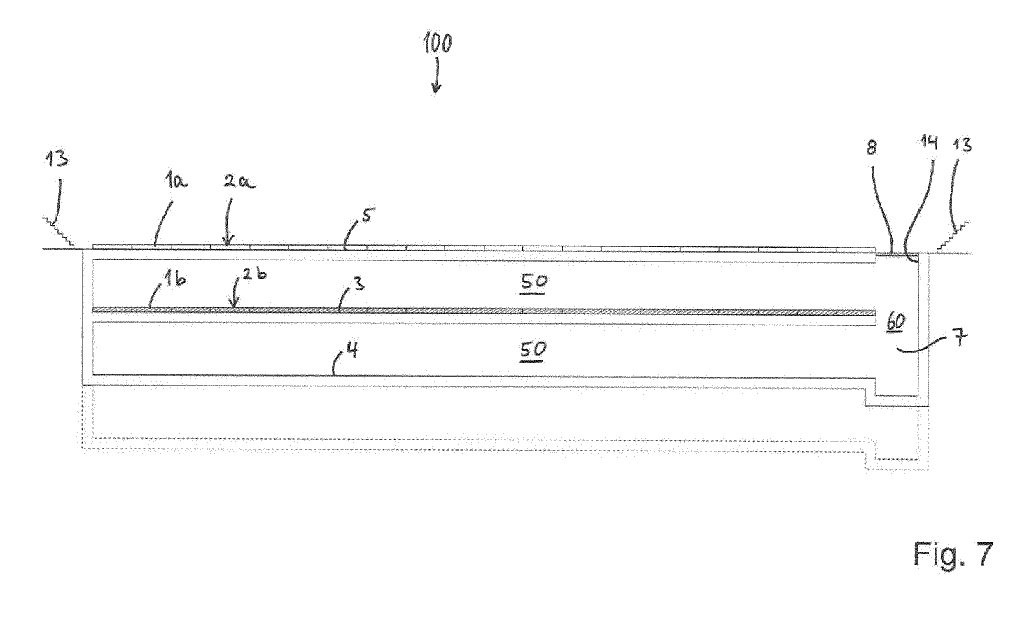

FIG. 7 illustrates a sports stadium 100 according to the invention, however with only one aperture 14. In order to replace a first field cover 2a with a second field cover 2b, one needs to transport field modules 1a of the first field cover 2a to the storage room 50 with the elevator 7 in before one can start moving field modules 1b of the second field cover 2b up from the storage room 50 to the fixed support base 5. In the embodiment shown in FIG. 7, one can transport the first field cover 2a down to the second level 4 of the storage room 50 and then transport the second field cover 2b up from the first level 3 of the storage room 50. Compared to the embodiment discussed with reference to FIG. 2 to FIG. 6, this will be more time consuming.

Reverting to the enlarged cross section view of FIG. 8, the elevator 7 in this embodiment can typically be a hydraulically powered scissor lift. Also illustrated in FIG. 8 are locking mechanisms 9 for the elevator plate 8. When locked into position in the aperture 14, the elevator plate 8 remains flush with the fixed support base 5 even if the lift 7 is lowered. Such locking mechanisms 9 can also be used to retain the ramp plate 61 of the pivoting ramp 6 in position in the aperture 14 (cf. FIG. 1).

FIG. 9 is an enlarged cross section view similar to FIG. 8. However, in this embodiment the aperture 14 is arranged partially below a portion of the spectators stand 13.

FIG. 10 shows the same embodiment as FIG. 9, in a situation where a field module 1 is about to be moved onto the elevator plate 8 of the elevator 7.

FIG. 11 shows a particular advantageous embodiment of a sports stadium 100 according to the invention. In this embodiment, the upper face of the field cover 2 is flush with a ground surface 5b which is adjacent the fixed support base 5. Thus, when a field cover is arranged on the fixed support base 5, level step between the field cover and the surrounding area. Although the locking mechanism 9 is shown in association with a field module 1a in this drawing, the locking mechanism 9 may advantageously be arranged in the same position as shown in FIG. 8, so that it is adapted to lock the elevator plate 8 in a position flush with the fixed support base 5.

FIG. 12 is a principle perspective view of an embodiment similar to the one shown in FIG. 2. However, in the embodiment of FIG. 12 the lift arrangements 60 are in the form of pivoting ramps 6. Moreover, the storage room 50 has only one level 3.

FIG. 13 to FIG. 18 are principle cross section views which illustrates the process of replacing a first field cover 2a with a second field cover 2b. As appears e.g. from FIG. 14, two pivoting ramps 6 are arranged at different places in the storage room 50. Thus, the field modules 1a of a first field cover 2a can be moved down to the storage room 50 on one pivoting ramp 6, while the field modules 1b of a second field cover 2b can be moved up to the fixed support base 5 on the other pivoting ramp 6.

FIG. 19 is a cross section view of another embodiment of a sports stadium 100 according to the invention. In this embodiment, the storage room 50 is provided with vehicle access ports 11 which are arranged at lateral positions of the storage room 50. Preferably, a vehicle access port 11 are arranged in association with a tunnel which makes a vehicle 15 able to reach the storage room from a street level position at a place outside the sports stadium 100. With this embodiment, vehicles 15 will be able to park in the storage room 50 below the fixed support base 5. This parking space may constitute a significant income for the stadium owner, such as during a cultural or sporting event, such as a concert or a football match.

Also shown in FIG. 19 are pivoting ramps 6. Some pivoting ramps are arranged at first and second levels 3, 4 of the storage room 50. Other pivoting ramps 6 are arranged flush with the fixed support base 5.

At the first level 3 of the storage room 50 shown in FIG. 19 there is arranged a vehicle support cover 2c. The vehicle support cover 2c can by one of many types of field covers 2. For instance it may be a field cover which is adapted to be arranged on the fixed support base 5 during a concert or a trade fair. By letting the vehicles 15 drive on and park on this vehicle support cover 2c, one obtains both storage of the field cover 2 as well as parking space for the vehicles 15. Of course, vehicles 15 may park in the storage room 50 without a particular vehicle support cover 2c made up by field modules.

FIG. 20 is an enlarged cross section view of yet an embodiment of the present invention. In order to facilitate movement of the field modules 1, the fixed support base 5, the first level 3 of the storage room 50, and the lift arrangement 60, which in this embodiment is in the form of the elevator 7, comprises a built-in driving assembly 10 adapted for moving field modules 1.

With such a driving assembly 10, the movement of field modules 1 can be automated to a large extent. In particular, by installing such a driving assembly 10 in the storage room 50, one can imagine having a plurality of levels 3, 4 in the storage room with reduced vertical distance between each level 3, 4. One may then avoid having to walk into the storing position of the field modules 1. In this manner one may store a significant number of field modules 1 by using only a small area of a storage room.

### LIST OF REFERENCE NUMBERS

14 aperture
10 driving assembly (built in driving assembly)
7 elevator
8 elevator plate
5 fixed support base
2 field cover
1 field module
5b ground surface (being adjacent the fixed support base)
3 first level of storage room
4 second level of storage room
60 lift arrangement
9 locking mechanism (for elevator plate)
62 pivot axis
6 pivoting ramp (with ramp plate)
61 ramp plate
13 spectators stand
100 sports stadium
50 storage room
15 vehicle
11 vehicle access port
2c vehicle support cover

1. A sports stadium with a fixed support base surrounded by a spectators stand, wherein a turf field cover is arranged on the fixed support base and is assembled by a plurality of field modules with a turf surface, the field modules are movable on the fixed support base, wherein an aperture constitutes access to a storage room at a level below the fixed support base and wherein a lift arrangement is arranged in association with the aperture and adapted for lowering and raising field modules between a level of the storage room and the level of the fixed support base,
wherein the storage room is provided with a vehicle access port on a lateral side of the storage room.

2. The sports stadium according to claim 1, wherein the lift arrangement is arranged in association with a side of the storage room.

3. The sports stadium according to claim 1, wherein the lift arrangement comprises a lift arrangement plate which is adapted to be fixed in the aperture in a position flush with the fixed support base.

4. The sports stadium according to claim 1, wherein the storage room comprises a plurality of levels and that vehicle access ports are arranged at such levels.

5. The sports stadium according to claim 1, wherein the lifting arrangement is in form of a pivoting ramp, which pivoting ramp exhibits a ramp plate that pivots between a lowered and raised position about a pivot axis arranged at the level of the fixed support base.

6. The sports stadium according to claim 1, wherein the upper face of the field cover, when arranged on the fixed support base, is flush with a ground surface adjacent the fixed support base.

7. The sports stadium according to claim 1, wherein a field cover stored in the storage room constitutes support for parked vehicles.

8. The sports stadium according to claim 1, wherein the storage room is positioned beneath the fixed support base.

9. The sports stadium according to claim 1, wherein the storage room is positioned in a position exterior to the space directly below the fixed support base.

10. The sports stadium according to claim 1, wherein the fixed support base, a level of the storage room, and the lift arrangement comprises a built-in driving assembly adapted for moving field modules.

11. A method of replacing a first field cover on a fixed support base of a sports stadium with a second field cover, the fixed support base being surrounded by spectators stands, wherein the first field cover and the second field cover comprise a plurality of field modules adapted to form a uniform surface when supported by the fixed support base,
the method comprising:
a) repeatedly moving field modules of the first field cover onto a first lift arrangement and lowering the field modules down to a level of a storage room arranged at a level below the level of the fixed support base, and when the first lift arrangement is at the level of the storage room, moving the field modules of the first field cover from the first lift arrangement to a storing position in the storage room;
b) repeatedly moving field modules of the second field cover, stored at a level in the storage room, onto a second lift arrangement and elevating the field modules up to the level of the fixed support base, and when the second lift arrangement is at the level of the fixed support base, moving the field modules of the second field cover onto the fixed support base and into a position to form a uniform surface with other field modules of the second field cover.

12. The method according to claim 11, wherein a first time period, in which step a) is performed, and a second time period, in which step b) is performed, are overlapping.

13. The method according to claim 11, the method comprising:
c) receiving vehicles into the storage room through a vehicle access port arranged on a lateral side of the storage room.

14. The method according to claim 13, wherein step c) comprises parking said vehicles on field modules stored in the storage room.

15. The method according to claim 11, wherein step a) comprises lowering the field modules of the first field cover to a first level of the storage room, and that step b) comprises raising the field modules of the second field cover from a second level of the storage room, wherein the first level is at another vertical elevation than the second level.
